(19) United States
(12) Patent Application Publication
(10) Pub. No.: US 2019/0132645 A1
(43) Pub. Date: May 2, 2019

(54) ELECTRONIC APPARATUS AND CONTROLLING METHOD THEREOF

(71) Applicant: SAMSUNG ELECTRONICS CO., LTD., Suwon-si (KR)

(72) Inventors: Sung Won KIM, Suwon-si (KR); Do Sung KIM, Suwon-si (KR); Young Joon YOO, Suwon-si (KR); Hyun Don YOON, Suwon-si (KR); Bong Seok LEE, Suwon-si (KR); Hee Ran LEE, Suwon-si (KR)

(73) Assignee: SAMSUNG ELECTRONICS CO., LTD., Suwon-si (KR)

(21) Appl. No.: 16/174,607

(22) Filed: Oct. 30, 2018

(30) Foreign Application Priority Data
Oct. 30, 2017 (KR) 10-2017-0142374

(51) Int. Cl. H04N 21/454; H04N 21/433; H04N 21/458; H04N 21/466; H04N 21/45

(52) U.S. Cl. CPC H04N 21/454; H04N 21/4331; H04N 21/4532; H04N 21/458; H04N 21/4667; H04N 21/4332

(57) ABSTRACT

An electronic apparatus is provided. The electronic apparatus includes a memory in which information relating to a user viewing history is stored, and a processor configured to identify a user-preferred content based on the stored viewing history information, and to provide information corresponding to the identified preferred content. The processor is further configured to, based on content that is being provided to the user including an advertisement that is not preferred by the user, provide information to the user corresponding to the identified user-preferred content.

### CROSS-REFERENCE TO RELATED APPLICATION

This application is based on and claims priority under 35 U.S.C. § 119(a) of a Korean Patent Application number 10-2017-0142374, filed on Oct. 30, 2017, in the Korean Intellectual Property Office, and the disclosure of which is incorporated by reference herein in its entirety.

### BACKGROUND

### 1. Field

The disclosure relates to an electronic apparatus and a controlling method thereof. More particularly, the disclosure relates to an electronic apparatus that identifies whether a content provided by the electronic apparatus is an advertisement content not preferred by a user, and providing information about a preferred content only when the content is a low-preferred advertisement content, and a controlling method thereof.

### 2. Description of Related Art

Electronic apparatuses store various contents or receive them from an external source, and provide them to users. Recently, electronic apparatuses have not only manually provided a content identified by a user, but also have provided a recommended content on the basis of viewing history information of the user without manual input from the user.

However, if a user-preferred content is present, a related-art electronic apparatus notifies the user of the user-preferred content. However, if the user is concentrating on a currently-viewed content, such the notification of the preferred content may alarm and inconvenience the user.

Thus, there is a demand for a method for appropriately determining a time point at which a user-preferred content is to be displayed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus that identifies whether a content provided by the electronic apparatus is an advertisement content not preferred by a user, and providing information about a preferred content only when the content is a low-preferred advertisement content, and a controlling method thereof.

In accordance with an aspect of the disclosure, an electronic apparatus is provided. The electronic apparatus includes a memory in which information relating to a user viewing history is stored, and a processor configured to identify a user-preferred content based on the stored viewing history information, and to provide information corresponding to the identified preferred content. The processor may be further configured to, based on a content provided by the electronic apparatus being an advertisement content not preferred by the user, provide the information corresponding to the identified user-preferred content.

The processor may be configured to identify whether the content provided by the electronic apparatus is an advertisement content, identify whether the identified advertisement content is an advertisement content not preferred by the user based on the stored viewing history information, and based on the identified advertisement content being an advertisement content not preferred by the user, to provide information corresponding to the identified user-preferred content.

The electronic apparatus may further include a communication interface configured to receive, from an external server, advertisement information regarding the content provided by the electronic apparatus. The processor may be configured to compare the received advertisement information with the stored viewing history information and identify whether the received advertisement information is an advertisement content not preferred by the user.

The advertisement information may include at least one of a company information, brand information, product information and content genre information regarding the advertisement content, and information about a text included in the advertisement content.

The processor may be configured to calculate a preference value of the identified advertisement content, and to identify whether the identified advertisement content is an advertisement content not preferred by the user based on the calculated preference value.

The processor may be configured to identify a genre of an advertisement content provided by the electronic apparatus, and to identify whether the advertisement content is an advertisement content not preferred by the user based on a user preference for the identified genre.

The processor may be configured to acquire a text by analyzing an image displayed by the content, and to identify whether the content is an advertisement content based on the acquired text.

The processor may be configured to compare the acquired text with the stored viewing history information and identify whether the content is an advertisement content not preferred by the user.

The processor may be configured to repeatedly provide information corresponding to the identified user-preferred content in units of advertisement content provided by the electronic apparatus.

The processor may be configured to, based on the content provided by the electronic apparatus being an advertisement content not preferred by the user, provide the identified user-preferred content information together with the advertisement content not preferred by the user.

In accordance with another aspect of the disclosure, a controlling method of an electronic apparatus is provided. The controlling method includes storing information relating to a user viewing history, identifying a user-preferred content based on the stored viewing history information, and providing information corresponding to the identified user-preferred content. The providing may include, based on a content provided by the electronic apparatus being an advertisement content not preferred by the user, providing information corresponding to the identified user-preferred content.

The providing may include identifying whether the content provided by the electronic apparatus is an advertisement content, identifying whether the identified advertisement content is an advertisement content not preferred by the user based on the stored viewing history information, and based on the identified advertisement content being an advertisement content not preferred by the user, providing information corresponding to the identified user-preferred content.

The identifying whether the identified advertisement content is an advertisement content not preferred by the user may include receiving, from an external server, advertisement information regarding the content provided by the electronic apparatus, and comparing the received advertisement information with the stored viewing history information and identifying whether the received advertisement information is an advertisement content not preferred by the user.

The advertisement information may include at least one of a company information, brand information, product information and content genre information regarding the advertisement content, and information about a text included in the advertisement content.

The identifying whether the identified advertisement content is the advertisement content not preferred by the user may include calculating a preference value of the identified advertisement content, and identifying whether the identified advertisement content is an advertisement content not preferred by the user based on the calculated preference value.

The identifying whether the identified advertisement content is the advertisement content not preferred by the user may include identifying a genre of an advertisement content provided by the electronic apparatus, and identifying whether the advertisement content is an advertisement content not preferred by the user based on a user preference for the identified genre.

The identifying whether the content provided by the electronic apparatus is the advertisement content may include analyzing an image displayed by the content and acquire a text, and identifying whether the content is an advertisement content based on the acquired text.

The identifying whether the identified advertisement content is the advertisement content not preferred by the user may include comparing the acquired text with the stored viewing history information and identifying whether the content is an advertisement content not preferred by the user.

The providing may include repeatedly providing information corresponding to the identified user-preferred content in units of advertisement content provided by the electronic apparatus.

In accordance with another aspect of the disclosure, a computer-readable recording medium including a program for executing a controlling method of an electronic apparatus is provided. The controlling method includes identifying a user-preferred content based on pre-stored information relating to a viewing history, and providing information corresponding to the identified user-preferred content. The providing may include, based on a content provided by the electronic apparatus being an advertisement content not preferred by the user, providing information corresponding to the identified user-preferred content.

In accordance with another aspect of the disclosure, an electronic apparatus includes a memory in which viewing history information of a user is stored; and a processor configured to provide content to the user; identify a user-preferred content based on the stored viewing history information; and based on the content provided to the user including an advertisement that is not preferred by the user, provide information to the user corresponding to the identified user-preferred content.

The processor may be configured to identify whether the content being provided to the user is an advertisement; and identify whether the identified advertisement is the advertisement that is not preferred by the user based on the stored viewing history information.

The electronic apparatus may further include a communication interface configured to receive, from an external server, advertisement information regarding the advertisement provided to the user, wherein the processor is configured to compare the received advertisement information with the stored viewing history information and identify whether the advertisement provided to the user is preferred or not preferred by the user according to a result of the comparison.

The advertisement information may include at least one from among company information, brand information, product information, genre information regarding the advertisement, and information about text included in the advertisement.

The processor may be configured to determine a preference value of the advertisement; and identify whether the advertisement is preferred or not preferred by the user based on the determined preference value.

The processor may be configured to identify a genre of the advertisement provided to the user; and identify whether the advertisement is preferred or not preferred by the user based on a user preference for the identified genre included in the stored viewing history information.

The processor may be configured to acquire displayed text included in the content provided to the user; and identify whether the content provided to the user includes an advertisement based on the displayed text.

The processor may be configured to compare the displayed text with the stored viewing history information and, based on a result of the comparison, identify whether the advertisement provided to the user is preferred or not preferred by the user.

The processor may be configured to repeatedly provide the information to the user corresponding to the identified user-preferred content during consecutive units of advertisement content provided to the user.

The processor may be configured to, based on the content being provided to the user being the advertisement that is not preferred by the user, provide the identified user-preferred content information together with the advertisement that is not preferred by the user.

In accordance with another aspect of the disclosure, a controlling method includes storing viewing history information of a user; providing content to the user; identifying a user-preferred content based on the stored viewing history information; and based on the content being provided to the user including an advertisement that is not preferred by the user, providing information to the user corresponding to the identified user-preferred content.

The providing may include identifying whether the content being provided to the user is an advertisement; and identifying whether the identified advertisement is the advertisement that is not preferred by the user based on the stored viewing history information.

The controlling method may further include receiving, from an external server, advertisement information regarding the advertisement provided to the user; and comparing the received advertisement information with the stored viewing history information and identifying whether the advertisement provided to the user is preferred or not preferred by the user based on a result of the comparison.

The advertisement information may include at least one from among company information, brand information, product information, genre information regarding the advertisement, and information about text included in the advertisement.

The identifying whether the advertisement provided to the user is preferred or not preferred by the user may include determining a preference value of the advertisement; and identifying whether the advertisement is preferred or not preferred by the user based on the preference value.

The identifying whether the advertisement provided to the user is preferred or not preferred by the user may include identifying a genre of the advertisement provided to the user; and identifying whether the advertisement is preferred or not preferred by the user based on a user preference for the identified genre included in the stored viewing history information.

The controlling method may further include acquiring displayed text included in the content provided to the user; and identifying whether the content is an advertisement based on the displayed text.

The identifying whether the advertisement provided to the user is preferred or not preferred by the user may include comparing the displayed text with the stored viewing history information and, based on a result of the comparison, identifying whether the advertisement provided to the user is preferred or not preferred by the user.

The providing the information corresponding to the identified user-preferred content may include repeatedly providing the information to the user corresponding to the identified user-preferred content during consecutive units of advertisement content provided to the user.

In accordance with another aspect of the disclosure, a computer-readable recording medium including a program for executing a controlling method of an electronic apparatus includes identifying a user-preferred content based on pre-stored viewing history information of a user; providing content to the user; and based on the content being provided to the user including an advertisement that is not preferred by the user, providing information to the user corresponding to the identified user-preferred content.

In accordance with another aspect of the disclosure, a display device includes a display configured to display content to a user; a memory configured to store viewing history information of the user; and a processor configured to determine whether the displayed content is preferred or not preferred by the user by comparing the displayed content to the stored viewing history information; in response to determining that the displayed content is not preferred by the user, identify content for recommendation to the user according to the stored viewing history information and output the content for recommendation to be displayed together with the displayed content.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, and advantages of certain embodiments of the disclosure will be more apparent from the following description taken in conjunction with the accompanying drawings, in which:

FIG. 1 is a brief block diagram illustrating a configuration of an electronic apparatus, according to an embodiment;

FIG. 2 is a detailed block diagram illustrating a configuration of an electronic apparatus, according to an embodiment;

FIG. 3 is a diagram illustrating a method for providing information about a user-preferred content, according to an embodiment;

FIGS. 4A and 4B are diagrams illustrating information about a viewing history, according to an embodiment;

FIG. 5 is a diagram illustrating an electronic program guide (EPG) metadata, according to an embodiment;

FIG. 6 is a diagram illustrating information about an advertisement content displayed on an electronic apparatus;

FIG. 7 is a diagram illustrating an operation of displaying one preferred content;

FIG. 8 is a diagram illustrating an operation of displaying a plurality of preferred contents;

FIG. 9 is a diagram in which the advertisement information displayed in FIG. 6 is displayed;

FIG. 10 is a diagram illustrating a genre and a detailed genre included in advertisement information;

FIG. 11 is a diagram illustrating a comparison of keywords, according to an embodiment;

FIG. 12 is a diagram illustrating a voice recognition function, according to another embodiment;

FIG. 13 is a diagram illustrating an operation of storing information received through the voice recognition function according to FIG. 12;

FIG. 14 is a graph showing a viewing time for each genre with respect to contents viewed by a user;

FIG. 15 is a diagram illustrating a beta distribution regarding whether the same advertisement is viewed or not;

FIG. 16 is a graph showing an operation of determining a preferred content on the basis of whether the same advertisement is viewed or not; and

FIG. 17 is a flowchart of a controlling method of an electronic apparatus, according to an embodiment.

The same reference numerals are used to represent the same elements throughout the drawings.

### DETAILED DESCRIPTION

Before specifically describing the present disclosure, a method for demonstrating the present specification and drawings will be described.

First of all, the terms used in the present specification and the claims are general terms identified in consideration of the functions of the various embodiments of the present disclosure. However, these terms may vary depending on intention, legal or technical interpretation, emergence of new technologies, and the like of those skilled in the related art. Also, there may be some terms arbitrarily identified by an applicant. Unless there is a specific definition of a term, the term may be construed based on the overall contents and technological common sense of those skilled in the related art.

Further, like reference numerals indicate like components that perform substantially the same functions throughout the specification. For convenience of descriptions and understanding, the same reference numerals or symbols are used and described in different exemplary embodiments. In other words, although elements having the same reference numerals are all illustrated in a plurality of drawings, the plurality of drawings do not mean one exemplary embodiment.

The present disclosure may have several embodiments, and the embodiments may be modified variously. In the following description, specific embodiments are provided with accompanying drawings and detailed descriptions thereof. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures the gist of the disclosure, the specific description is omitted.

In the present disclosure, relational terms such as first and second, and the like, may be used to distinguish one entity from another entity, without necessarily implying any actual relationship or order between such entities. In embodiments of the present disclosure, relational terms such as first and second, and the like, may be used to distinguish one entity from another entity, without necessarily implying any actual relationship or order between such entities.

The terms used herein are solely intended to explain a specific exemplary embodiment, and not to limit the scope of the present disclosure. It is to be understood that the singular forms “a,” “an,” and “the” include plural referents unless the context clearly dictates otherwise. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

The term such as “module,” “unit,” “part”, and so on is used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Also, when any part is connected to another part, this includes a direct connection and an indirect connection through another medium. Further, when a certain portion includes a certain element, unless specified to the contrary, this means that another element may be additionally included, rather than precluding another element.

In an example embodiment, a content may refer to a program, a channel, etc. provided by an electronic apparatus, and may refer to an advertisement or a service. In addition, an advertisement content and an advertisement may have similar meanings. In addition, history information may refer to information relating to a viewing history.

In addition, in an embodiment, user-preferred content may be, recommended or may be provided immediately without first being recommended. If an electronic apparatus has a display, providing a preferred content may refer to displaying the preferred content on a display or displaying a user interface (UI) for a user to identify a plurality of preferred contents. The history information may also refer to information relating to a viewing history. Meanwhile, the term “user-preferred content” or “user low-preferred content” may have the same meaning as the preferred content or the low-preferred content.

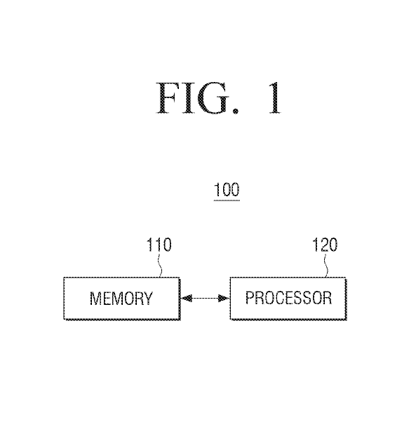

FIG. 1 is a brief block diagram illustrating a configuration of an electronic apparatus (i.e., display device), according to an embodiment.

Referring to FIG. 1, the electronic apparatus 100 may include a memory 110 and a processor 120.

The electronic apparatus 100 may be implemented as a variety of devices such as a computer, TV, set-top box, smartphone, smart watch and the like. The electronic apparatus 100 may be implemented to be an analog TV, a digital TV, a 3D-TV, a smart TV, an LED TV, an OLED TV, a plasma TV, a monitor, a curved TV having a fixed screen curvature, a flexible TV having a fixed screen curvature, a bended TV having a fixed screen curvature, and/or a curvature modifiable TV in which the curvature of the current screen can be modified by a received user input. However, it may not be limited to the above.

The memory 110 corresponds to a space where a data is stored. The memory 110 may store information relating to a viewing history of the electronic apparatus 100. In addition, the memory 110 may store advertisement information, etc., and may store data obtained by analyzing information about the viewing history, advertisement information, etc. The stored information may include an on/off time, viewing history (channel, title, additional information about a program, etc.), application execution history, an input history such as a remote controller input, a voice input and the like, a function use history (menu, etc.), and may include information about a use time. The stored information may be deleted when a predetermined time has elapsed.

In addition, a weight W1, W2 and W3 assigned to a history may be stored in the memory 110, and the stored weight may be updated at a predetermined time point.

The memory 110 may be controlled by the processor 120 to store a variety of application programs, data and software modules for driving and controlling the electronic apparatus 100. For example, the memory 110 may include a history storing/analysis module for storing a use history of a content provided by the electronic apparatus 100, a curator module for identifying a preferred content, a content exposure module for providing information about the identified preferred content, a voice recognition module, an image recognition module, etc.

History information may include, for example, a device on/off time of the electronic apparatus, a content use history, input information (remote controller, voice, etc.), a function use history (menu history, etc.), and so on. The memory 110 may store history information for each of at least one content provided by the electronic apparatus 100 and may organize the history information by day and/or time. In detail, the history information may include information about when (date and time) a particular content is used and for how long it is used (use time). A new history information entry associated with a viewing session of a particular content may be added as a user uses the content and the history information may be updated.

The content may be, for example, a broadcasting channel and a broadcasting content (e.g., video on demand (VoD) and streaming content (image, music, etc.)), or may be a plurality of applications and functions executable in the electronic apparatus 100. That is, the history information may include, for example, information about when a particular broadcasting channel is watched and how long it is watched, information about when a particular application is used and how long it is used, and information about when a particular content is reproduced and how long it is reproduced. However, the example is not limited thereto, and various history information may be included in the memory 110 depending on the content the electronic apparatus 100 provides.

The memory 110 may be implemented as a non-volatile memory, a volatile memory, a flash memory, a hard disk drive (HDD) or a solid state drive (SDD). The memory 110 may be implemented not only as a storage medium in the electronic apparatus 100 but also as an external storage medium such as a micro SD card, a USB memory or a Web server through a network.

The processor 120 may control an overall operation of the electronic apparatus 100. For example, according to a control command of a user, a content pre-stored in the electronic apparatus 100 or a content provided from an external apparatus may be displayed. In an implementation, in a case that the electronic apparatus is implemented as a set-top box, the displaying operation described above may be replaced with an operation of transmitting the content to a display apparatus.

The processor 120 may identify a user-preferred content. The processor 120 may analyze information relating to a viewing history and identify a user-preferred content (i.e., content preferred by the user) by means of a predetermined method, which will be described in detail later.

The processor 120 may provide information corresponding to the identified preferred content. For example, if a content that is currently being provided from the electronic apparatus 100 is a user low-preferred content (i.e., the user does not prefer the content), the processor 120 may provide information to the user corresponding to the previously identified preferred content.

The processor 120 may identify whether the content currently being provided by the electronic apparatus is a broadcasting content, identify whether the identified broadcasting content is a user low-preferred advertisement content on the basis of the stored viewing history information, and if the identified broadcasting content is a user low-preferred advertisement content, provide information corresponding to the previously identified user-preferred content.

For example, if a brand or a particular slogan is present in a content provided by the electronic apparatus 100 for more than a predetermined time, the processor 120 may identify that a content currently provided in the electronic apparatus 100 is a broadcasting content.

To this end, an automatic content recognition function may be used. The automatic content recognition function is a technology wherein, when it is determined that a user is interested in content that appears while the user is viewing a smart TV, a smartphone, a smart PC, a game console, etc. the function automatically finds a price, manufacturer, etc. of a corresponding product and allows purchase of the product. When the automatic content recognition function is used, it is possible to find a content such as an image, a voice, etc. desired by the user, and to perform search on the basis of data included in a video, etc.

The processor 120 may compare the received advertisement information and the stored viewing history information and identify whether the content is a user low-preferred advertisement content. For example, the acquired information and the viewing history information may be compared on the basis of at least one of a keyword, a genre, and whether the same advertisement has previously been watched.

When the comparison is keyword-based, a keyword of a content preferred by the user may be identified by analyzing the viewing history information, and the identified keyword may be compared with a keyword included in the acquired information.

When the comparison is genre-based, the processor 120 may identify a genre of an advertisement content provided by the electronic apparatus, and identify whether the advertisement content is a user low-preferred advertisement content on the basis of whether the identified genre is preferred by the user or not. For example, if a soccer shoe by a sports brand is advertised, the genre may correspond to sports. In addition, a subgenre may correspond to soccer. A user-preferred genre may be analyzed through information relating to a viewing history on the basis of the genre and the subgenre. The processor 120 may compare genres of contents viewed by the user, and if a predetermined ratio of the user's viewed content belongs to the genre, recognize the content as a preferred content.

In this case, to analyze a preferred genre, the processor 120 may analyze a user viewing history, which is not necessarily limited to advertisements. If a content viewed by the user is a sports channel or a sports program, a cumulative viewing time of the sports genre may be increased.

In general, a viewing time of a sports channel or a sports program may be longer than that of an advertisement. Therefore, it may be considered that watching sports contents rather than watching sports advertisements is more important for forming preferred contents. However, this is only an example, and if it is analyzed that viewing sports advertisements has a high proportion, the proportion of advertisements in the formation of preferred contents may be increased.

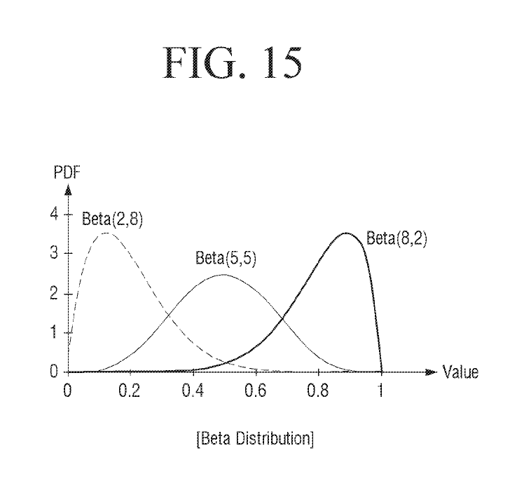

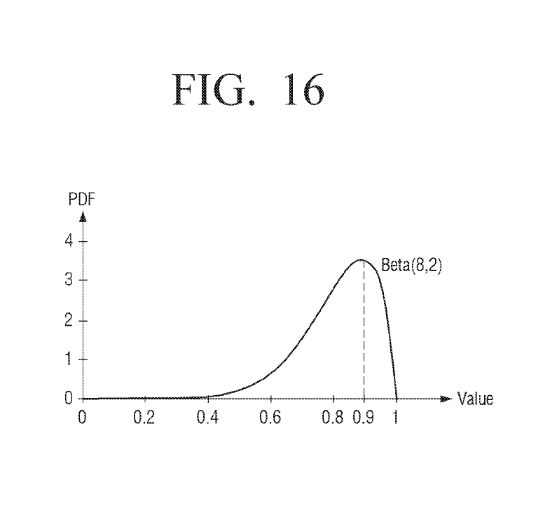

The processor 120 may compare a result of determination of whether the same advertisement has previously been viewed, with the acquired information. For example, whether the user has watched the same advertisement may be determined, and the advertisement may be determined as a preferred content on the basis of information thereon. In this case, if the same advertisement has been viewed more than a predetermined number of times, the advertisement may be determined as a preferred content. In addition, a beta distribution may be used on the basis of a number of times the user has viewed the advertisement and a number of times the user has performed an operation to transition away from the advertisement when it is displayed. The detail will be described below with reference to FIGS. 15 and 16.

Meanwhile, the processor 120 may compare the advertisement information relating to a content provided by the electronic apparatus 100 received from an external server with the stored viewing history information, and identify whether the content is a user low-preferred advertisement content. The advertisement information may include at least one of manufacturer information associated with the advertisement content, brand information, product information, content genre information, and text information included in the advertisement content.

In general, the electronic program guide (EPG) metadata may only include information about a program, and may not include information about an advertisement. Accordingly, in order to obtain information about an advertisement from the electronic apparatus 100, it is necessary to use the automatic content recognition technology described above, or to receive advertisement metadata. The advertisement metadata may be received via an external server. In this case, the received advertisement metadata may include business information related to an advertisement content, brand information, product information, content genre information, information about a text included in the advertisement content, etc.

In this case, the processor 120 may analyze the received information about the advertisement metadata and compare the analyzed information with information relating to a viewing history of a user. The processor 120 may determine whether an advertisement content currently provided by the electronic apparatus 100 is a user-preferred content or a user low-preferred content, using the advertisement metadata.

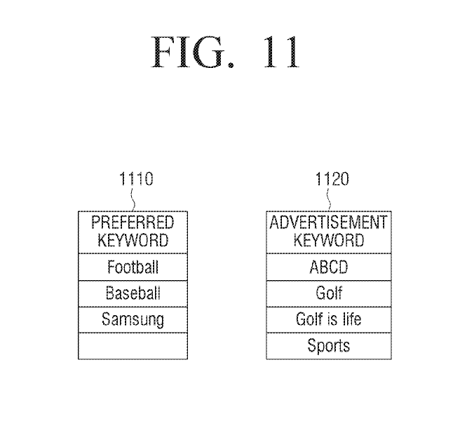

In addition, the processor 120 may calculate a preference value for an advertisement content currently provided by the electronic apparatus 100, and identify whether the advertisement content is a user low-preferred advertisement content on the basis of the calculated preference value. For example, the preference value may be calculated by determining a degree of similarity between keywords. The detail of preference calculation will be described below with reference to FIG. 11.

Meanwhile, the processor 120 may repeatedly provide information corresponding to the identified user-preferred content during consecutive units of advertisement content. It will be assumed that approximately ten minutes of advertisement time is provided between a program and the next program. In this case, an advertisement viewed by the user may be, in general, 10-15 seconds. Accordingly, approximately four advertisements may be viewed by the user in one minute. In this case, the processor 120 may determine whether the respective advertisements are preferred contents, and identify whether it is possible to display a preferred content.

If a content provided in the electronic apparatus 100 is a user low-preferred advertisement content, the processor 120 may provide the identified user-preferred content information together with the user low-preferred advertisement content. For example, the providing the information together with the content may refer to simultaneously providing the information about the user-preferred content and the user low-preferred advertisement content. In addition, if the electronic apparatus 100 includes a display, it may mean displaying the preferred content information on top of the low-preferred advertisement content, or may mean separating the preferred content information and the low-preferred advertisement content by splitting the display in an up-down or left-right direction. As such, the providing the information together with the content may correspond to a variety of methods in which the user is capable of recognizing the low-preferred advertisement content and the preferred content information at the same time.

The preferred content information may include at least one of a content name, a content type, a content start time, a content ending time, and the number of content views.

As described above, the electronic apparatus 100 according to an example embodiment may acquire information about an advertisement currently provided in the electronic apparatus 100 and identify whether the advertisement corresponds to a preferred content. Thereby, it is possible to provide the user with information about a preferred content at the same time as an advertisement content not preferred by the user is displayed.

In addition, the electronic apparatus 100 according to another example embodiment may receive advertisement metadata from an external server and identify whether an advertisement content currently provided in the electronic apparatus 100 is an advertisement content not preferred by the user. The advertisement metadata received from an external source may include detailed information and thus, it is possible to accurately analyze whether the advertisement content is a content not preferred by the user.

The electronic apparatus 100 according to an embodiment may, if a low-preferred advertisement is provided, simultaneously provide information about a preferred content and thus, it is possible to reduce a user's inconvenience and to increase user satisfaction.

In FIG. 1, the processor 120 provides content information for an operation of providing a preferred content. However, in an implementation, transformation to a preferred content may be performed immediately or after a predetermined time elapses.

In the electronic apparatus 100 according to an example embodiment, the processor 120 performs an operation such as immediately transforming (displaying) a content under a particular condition, etc., and thus the user can readily access a desired content without accessing an additional menu, thereby enhancing the user convenience.

In the electronic apparatus 100 according to an embodiment, the processor 120 identifies whether a content is advertisement, and performs both identification of whether the content is a low-preferred advertisement, and identification of a preferred content. However, at least one of the operations described above may be performed in an external server and the resulting data may be provided to the electronic apparatus 100.

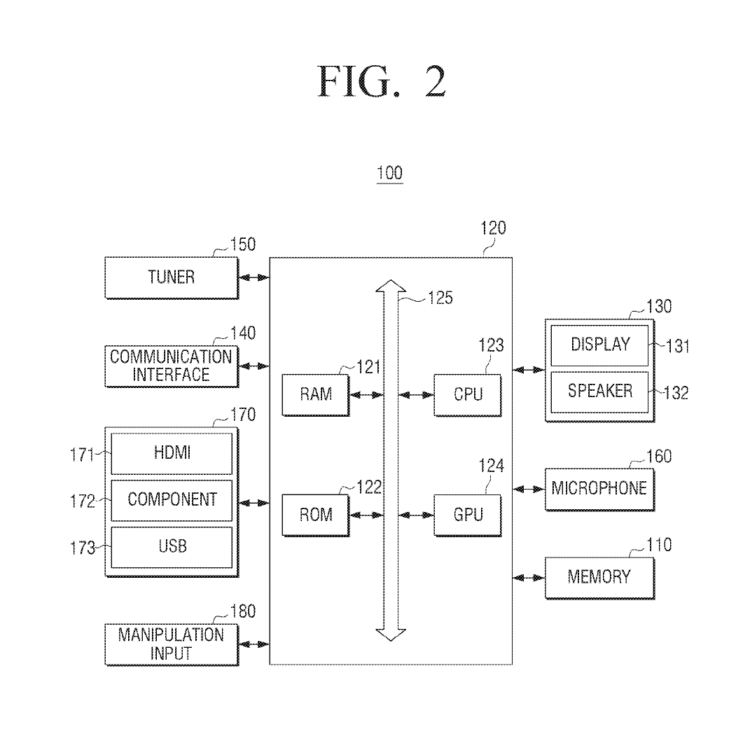

Meanwhile, although the above illustrates and describes only the brief configuration of the electronic apparatus 100, various units may be additionally included in actual implementation. It will be explained below by referring to FIG. 2.

FIG. 2 is a detailed block diagram illustrating a configuration of an electronic apparatus, according to an embodiment.

Referring to FIG. 2, the electronic apparatus 100 may include a memory 110, a processor 120, an output interface 130, a communication interface 140, a tuner 150, a microphone 160, a port 170, and a manipulation input interface 180.

Since a detailed operation of the memory 110 has been described in detail with reference to FIG. 1, a redundant description will be omitted.

The electronic apparatus 100 may directly perform voice recognition by receiving a voice input via a built-in microphone or a microphone built in an external apparatus, or may transfer the received voice input to an external server performing voice recognition and receive the voice recognition result.

If the electronic apparatus 100 directly performs voice recognition, an artificial intelligence (AI) system for voice recognition may be provided. The AI system is a computer system which implements intelligence at a human level, wherein a machine learns and improves with use. A voice input may be recognized through a linguistic understanding technology for recognizing languages/characters of a human being from among AI technologies. The linguistic understanding is a technique of recognizing a language and character of a human and applying and processing the same, which includes natural language processing, machine translation, a conversation system, question and answer, voice recognition and synthesis, and the like.

According to another embodiment, an additional external apparatus with a built-in microphone may be present, and the external apparatus may perform voice recognition processing for the voice input and provide the voice recognition result to the electronic apparatus 100.

The electronic apparatus 100 may be controlled on the basis of the voice recognition result. For example, if the voice recognition result includes “Please show channel recommendation.”, preferred channels may be identified and information about the identified preferred channels may be provided through the output interface 130. In this case, the example may be a particular program or a particular content instead of a channel.

The processor 120 may include a random access memory (RAM) 121, a read only memory (ROM) 122, a central processing unit (CPU) 123, a graphics processing unit (GPU) 124, and a bus 125. The RAM 121, the ROM 122, the CPU 123, the GPU 124, etc. may be connected to each other through the bus 125. The processor 120 may be realized as a system on chip (SoC).

In the processor, the GPU 124 of the processor 120 may analyze images and the CPU 123 may control overall operation.

The CPU 123 may access the memory 110 to perform booting using the OS stored in the memory 110. The CPU 123 may perform various operations by using the various programs, contents, data, and the like stored in the memory 110. The CPU 123 may perform the operation of the processor 120 described with reference to FIG. 1.

In detail, the GPU 124 may, when booting of the display apparatus 100 is completed, generate a screen that includes various objects such as an icon, an image, a text, and the like. The GPU may be configured as a separate feature such as an image processor, and may be realized as, for example, a System on Chip (SoC) that is combined with the CPU within the processor 120.

The ROM 122 may store a set of instructions for system booting. When a turn-on command is input and thus the electric power is supplied, the CPU 123 may copy the stored OS in the memory 110 to RAM 121 according to the commands stored in ROM 122, and boot the system by executing the OS. If booting is completed, the CPU 123 performs various operations by copying various types of application programs stored in the memory 110 into the RAM 121 and executing the application programs copied into the RAM 121. The processor 120 may perform various operations using a module stored in the memory 110.

The output interface 130 may include a display 131 for outputting images, and a speaker 132 for outputting audio.

The display 131 may display an image so that a preferred content provided by the processor 120 may be viewed by a user. In addition, a UI element may be additionally displayed to the user while the image is displayed. The UI element may be a phrase that requests identification of the user, or may be a menu displaying a plurality of preferred contents. The UI element is not limited to particular contents, and may be an interface distinct from the displayed content.

The display 131 may be realized as a Liquid Crystal Display (LCD), a Plasma Display Panel (PDP), or Organic Light Emitting Diodes (OLED). The display 131 may also include a touch screen.

The speaker 132 refers, for example, to a component that outputs audio. The speaker 132 is sound equipment which transforms an electrical signal into a vibration of a vibration plate, generate a condensation and rarefaction wave in the air, and copies a sound wave, which may output voice data.

The communication interface 140 is configured to communicate with various kinds of external devices in various communication methods. The communication interface 140 may receive, from an external server, advertisement information related to a content provided by the electronic apparatus.

The communication interface 140 may be connected to an external device via a Local Area Network (LAN) or the Internet, and may be connected to the external device in a wireless communication method such as Z-wave, 4LoWPAN, radio frequency identification (RFID), Long Term Evolution (LTE) D2D, BLE, GPRS, Weightless, Edge Zigbee, ANT+, NFC, IrDA, digital enhanced cordless telecommunications (DECT), wireless local area network (WLAN), Bluetooth, Wi-Fi, Wi-Fi Direct, global system for mobile communications (GSM), Universal Mobile Telecommunication System (UMTS), LTE, wireless broadband (WiBRO), and the like. The communication interface 140 may include a Wi-Fi chip, a Bluetooth® chip, an NFC chip, and a wireless communication chip. The Wi-Fi chip, the Bluetooth chip, and the NFC chip perform communication according to a Wi-Fi method, a Bluetooth method, and an NFC method, respectively. The wireless communication chip represents a chip which communicates according to various communication standards such as IEEE, Zigbee, 3rd Generation (3G), 3rd Generation Partnership Project (3GPP), LTE and so on. In addition, the communication interface 140 may include an optical receiver which is capable of receiving a control signal (e.g., IR pulse) from an external apparatus. A user command input to the external apparatus via the communication interface 140 may be received, information about an identified recommended service may be transferred to an external user terminal via the communication interface 140, and data transception with the server may be performed via the communication interface 140.

The tuner 150 may receive video, audio, and data in a frequency band corresponding to a channel number received by user input.

The tuner 150 may receive broadcast signals from various sources such as terrestrial broadcasting, cable broadcasting, and satellite broadcasting. The broadcasting signals may be analog broadcasting and digital broadcasting.

The tuner 150 may be embedded within the electronic apparatus 100 or implemented as a separate apparatus including the tuner unit electrically connected to the electronic apparatus 100 (e.g., set-top box or a tuner connected to the port 170).

The tuner 150 may tune only a frequency of a channel that the electronic apparatus 100 intends to receive, among many radio wave components by amplifying, mixing, resonating, etc. broadcast signals received in a wired or wireless manner to identify the broadcast signal. The broadcast signals may include a video, an audio, and additional data (for example, EPG).

The microphone 160 may directly perform voice recognition by receiving a voice input, or may transfer the received voice input to an external server performing voice recognition and receive the voice recognition result. In addition, the microphone 160 may receive not only a person's voice but also a sound signal. A sound signal transferred from the microphone 160 may be received, and a sound signal of an inaudible region as well as a sound signal of an audible region may be received.

The microphone 160 may convert information about the received sound into an electrical signal.

The microphone 160 may include a variety of components such as a microphone to collect a user voice of an analog format, an amplifier circuit to amplify the collected user voice, an analog/digital converter circuit to sample the amplified user voice and convert the sampled user voice to a digital signal, a filter circuit to remove a noise component from the converted digital signal, and the like.

The port 170 is a configuration for connecting with an external apparatus. The port 170 may include at least one of a High-Definition Multimedia Interface (HDMI) input port 171, a component input jack 172, and a Universal Serial Bus (USB) port 173. The port 170 may further include at least one of ports such as Red, Green and Blue (RGB), Digital Visual Interface (DVI), high-definition multimedia interface (HDMI), DisplayPort (DP), thunderbolt port, and the like. It is possible to transfer information about a recommended service to an external apparatus via the port 170.

The manipulation input interface 180 may receive input of a user identification for a preferred content displayed on the display 131. The manipulation input interface 180 may be implemented to be a device such as a button, a touch pad, a mouse and a keyboard, or may be implemented as a touch screen that can also perform the displaying function and the manipulation input function.

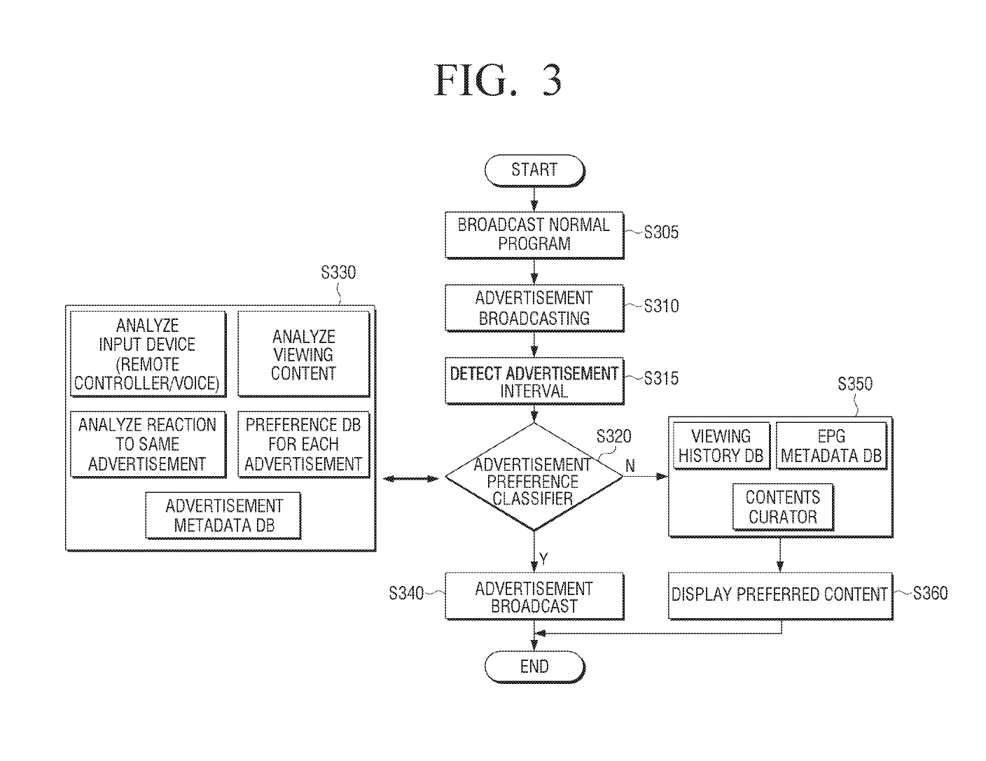

FIG. 3 is a diagram provided to explain an electronic apparatus 100, according to another example embodiment.

Referring to FIG. 3, an broadcast advertisement content may be displayed at operation S310 after a normal broadcasting program at operation S305 ends to before a new normal program starts. In this case, the processor 120 may detect the advertisement interval between the normal programs at operation S315. Thereafter, if the content is determined to be an advertisement, it may be determined whether the advertisement is a preferred advertisement or a low-preferred advertisement of the user, at operation S320.

To determine whether the advertisement is a preferred advertisement, information about the advertisement may be analyzed at operation S330. Any one or more of information obtained by analyzing a user command (an act of pressing a button or recognizing a voice) received through an input apparatus, information obtained by analyzing a viewing content, information obtained by analyzing reactions to the same advertisement, information stored in a database (DB) indicating a preference for each advertisement, a DB storing advertisement metadata DB, etc. may be used to determine whether the advertisement content is preferred by the user.

If the advertisement is a preferred advertisement, the processor 120 may broadcast the advertisement as it is, at operation S340. If the advertisement is a low-preferred advertisement, the processor 120 may determine a preferred content to display instead, at operation S350. The processor 120 may use a viewing history DB, an EPG metadata DB, information analyzed by a contents curator, etc. The information obtained from analysis of the contents curator may refer to information which is generated by analyzing information about a user viewing history and storing a content appropriate for the user in a list format.

The processor 120 may display a preferred content on the basis of the viewing history DB, the EPG metadata DB, the information analyzed by the contents curator, etc., at operation S360.

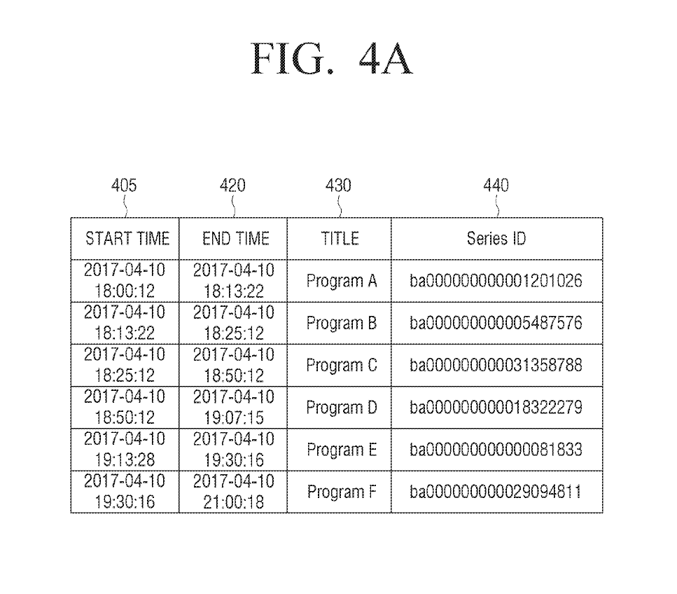

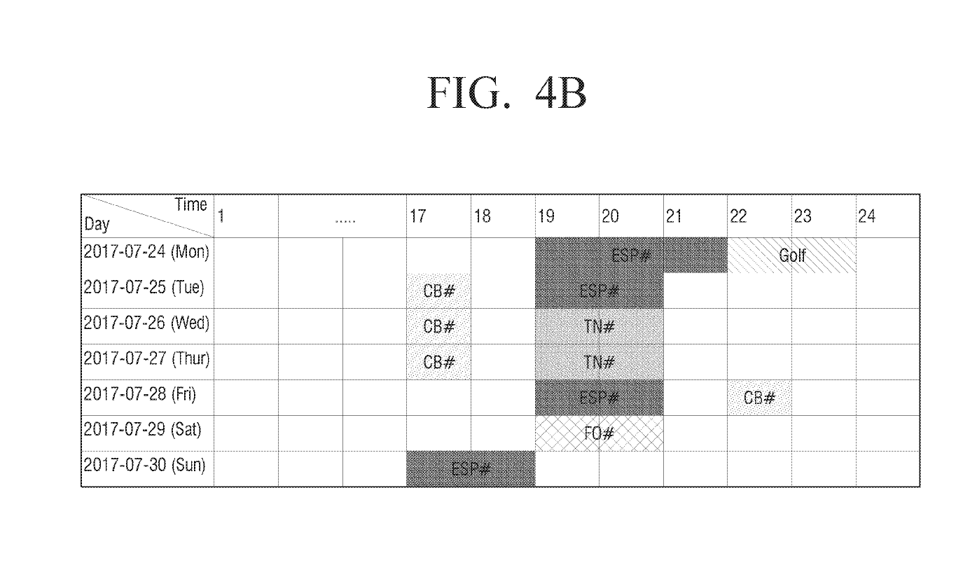

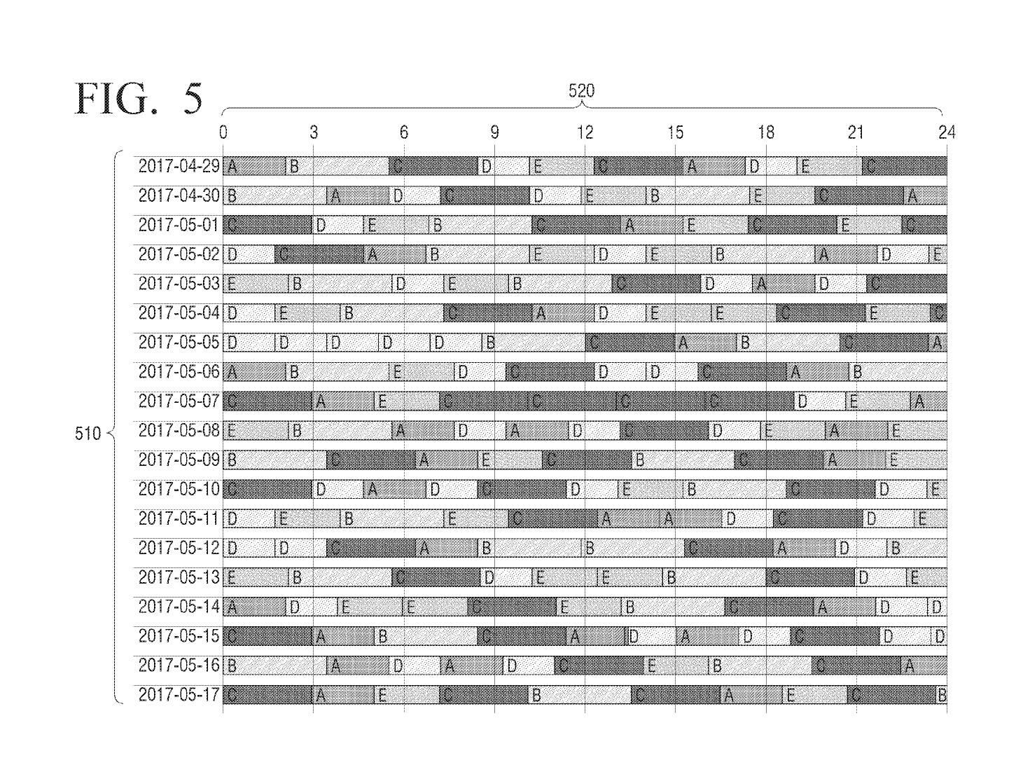

The information relating to the viewing history, the EPG metadata, etc. is briefly explained with reference to FIGS. 2 and 3. An example embodiment of the information about the viewing history and the EPG metadata will be described in greater detail below, with reference to FIGS. 4A, 4B and 5.

FIGS. 4A and 4B are diagrams provided to explain information about a viewing history, according to an example embodiment.

FIG. 4A is a diagram provided to explain information relating to a viewing history including a viewing start time and a viewing ending time.

Referring to FIG. 4A, information relating to a viewing history of a program may be identified. The information relating to the viewing history may be divided into a viewing start time 405, a viewing ending time 420, a title 430 of the viewed content, a series ID 440, and so on. If a user views a particular program, the viewing start time, the viewing ending time, etc. may be stored as an entry in the information relating to the viewing history.

Meanwhile, an operation of analyzing information relating to a viewing history according to another embodiment will be described.

FIG. 4B is a diagram provided to explain various embodiments to identify a content recommended on the basis of history information.

According to an embodiment, the stored viewing history information may include a plurality of entries corresponding to viewing sessions of the user, and the plurality of entries may each include a duration of a viewing session, a time of day of the viewing session, a date of the viewing session, a day of the week of the viewing session, and a content viewed during the viewing session.

Referring to FIG. 4B, it will be assumed that a plurality of contents are broadcasting channels, and that a channel viewing history from 24 Jul. 2017 to 30 Jul. 2017 is present in the memory 110. When a particular event (e.g., a user pressing a particular button of a remote controller) occurs at 8 p.m. on 4 Aug. 2017 after the information shown in FIG. 4B has been stored, a first weight W1 may be assigned to entries corresponding to the same approximate time of day (i.e., 8 p.m.), a second weight W2 may be assigned to entries corresponding to the day of the week (i.e., Saturday), and a third weight W3 may be assigned to entries corresponding to other days of the week and times of day, thereby calculating a usage index of each of a plurality of broadcasting channels.

According to an embodiment, a first weight may be assigned to entries that include a time of day corresponding to the current time of day and a second weight lower than the first weight may be assigned to entries that include a time of day that does not correspond to the current time of day, and the content for recommendation may be identified to the user based on the assigned first weight and second weight.

According to an embodiment, a first weight may be assigned to entries that include a day of the week corresponding to the current day of the week and a second weight lower than the first weight may be assigned to entries that include a day of the week that does not correspond to the current day of the week, and the content for recommendation may be identified to the user based on the assigned first weight and second weight.

The calculation may be performed by hour, and according to another embodiment, the calculation may be performed in units of a period from a viewing start time of a particular channel to a viewing ending time of the particular channel.

According to an embodiment, the plurality of entries may be assigned a weight according to a difference between the date included in the entries and the current date, and the content for recommendation may be identified to the user based on the assigned weight.

According to another embodiment, the usage index may be calculated by applying a reduction value corresponding to the age of the entry. That is, in the embodiments described above, the usage index is calculated on the basis of “time of use (T)×weight (W)”. However, according to an embodiment to which the reduction value is applied, the usage index may be calculated on the basis of “reduction value (R)×time of use (T)×weight (W)”.

The reduction value may be set such that a reduction ratio becomes larger as the date of the entry is older. For example, the reduction value (R) may be defined as shown below.

Reduction value (R)=(1−r)̂d,

where 0<r<1, and the d is a difference between the date of the entry and the current date.

As described above, the concept of reduction value is applied, the usage index is calculated by reflecting a recent use history to which a larger weight is given, and thus there is an advantage that a recommended content that is more appropriate for a recent content use tendency of the user can be provided.

In the examples described with reference to FIG. 4B, history information of a week is used. However, the example is not limited thereto, and history information of the past several days or history information of the past several weeks may be used, or information of the entire history cumulated from the first date of use may be used.

The processor 120 may identify a recommended content on the basis of the calculated usage index. For example, if a size of usage index is in the order of ESP# channel >TN# channel >FO# channel >CB# channel >Golf channel from largest to smallest, the processor 120 may identify the ESP# channel having the highest usage index as a recommended content, or may rank the ESP# channel, TN# channel and FO# channel (e.g., first, second, and third) as recommended contents.

In addition, the processor 120 may provide information about the identified recommended content via the output interface 130.

The output interface 130 is a component capable of providing information about a recommended content, which may be, for example, implemented as a speaker 132 or a display 131 included in the electronic apparatus 100.

If the electronic apparatus is TV and a content to be recommended is a broadcasting channel, when a particular event occurs (e.g., when a particular button of a remote control apparatus is pressed), a UI element which identifies at least one recommended channel may be displayed. The user may identify a desired channel via the UI element and view the corresponding channel. When the number of contents identified as the recommended contents is plural, the recommended contents may be provided in the order from largest usage index to smallest usage index.

In a different manner, if the user is viewing a UI which scrolls through broadcasting channels, an indicator (e.g., star-shaped mark) may be displayed next to a recommended broadcasting channel as the recommended broadcasting channel scrolls through the UI.

The processor 120 of the electronic apparatus 100 may provide the above-mentioned scrolling UI. A plurality of channels may mapped to the scrolling UI, and a channel may be identified by moving the cursor up and down using a remote control apparatus. For example, when the cursor moves and stays at a particular location for a predetermined time, a channel corresponding to the stopped location of the cursor may be identified. An indicator indicating a place where the identified recommended channels may be displayed on the scrolling UI. The user may move the cursor to the place where the indicator is located, and thereby identify a recommended channel.

Alternatively, a recommended broadcasting channel may be displayed on the EPG differently (e.g., in a different color) from the other broadcasting channels.

Meanwhile, when the electronic apparatus 100 is a smartphone and a particular event occurs (e.g., when “RECOMMENDED” is touched), a UI element capable of showing recommended music may be displayed. The user may identify desired music via the UI element and reproduce the corresponding music.

In a case that a content to be recommended is an application, when a particular event occurs (e.g., a predetermined time is reached), a UI element including an icon of a recommended application may be displayed. The user may identify a desired application via the UI element and execute the identified application. If the user presses a “view more” button, for example, applications of the next ranking, that is, applications having the second largest usage index, may be displayed.

In the example described above, the recommendation information is provided by the electronic apparatus 100. However, it is possible that the recommendation information is provided from an apparatus external to the electronic apparatus 100. For example, in a case that the electronic apparatus 100 is implemented as a smartphone, information about recommended contents may be provided on an ultra large screen apparatus such as a TV, using a wireless communication such as Mirroring, Digital Living Network Alliance, Wi-Fi, or the like, and the information about the recommended contents may be displayed on the ultra large screen apparatus.

According to an embodiment, a self-validated pattern classifier may be applied to provide adaptive content recommending according to a content usage pattern for each user. For example, a weight value W1, W2 and W3 assigned to history entries may be adaptively determined according to the content usage pattern of the user, and thereby a content that further fits the user's tendency can be recommended. To this end, according to an embodiment, it is possible to use a content usage pattern index for which digitization is performed with respect to the content usage pattern of the user.

The content usage pattern index may be, for example, generated by digitizing a content usage pattern of the user, such as a content usage pattern of a user who usually uses the content only at a particular time of day, a content usage pattern of a user who usually uses the content only on a particular day, a content usage pattern of a user who uses the content evenly throughout all times of day, or the like. The processor 120 may calculate a usage pattern index of the content on the basis of history information stored in the memory 110.

The concept of variance may be applied, and the content usage pattern index may be set such that the content usage pattern index increases as variance increases. Accordingly, the content usage pattern index of the user having a large content usage weight only on a particular day or only at a particular time may be larger than the content usage pattern index of the user who uses the content evenly throughout all times of day or throughout all days of the week.

The content usage pattern index may include at least one of a day pattern index and a time pattern index. The day pattern index may be calculated on the basis of the usage history for each day of the week, and the time pattern index may be calculated on the basis of the usage history for each time of day.

To explain one example of a method for calculating a day pattern index, the processor 120 may calculate a variance for the use time for each day with respect to each of a plurality of contents on the basis of the entries stored in the memory 110, and calculate a day pattern index on the basis of the calculated variance. For example, in a case that entries are stored for first to third contents, the processor 120 may calculate a variance for the usage time for each day of the week with respect to the first content, calculate a variance for the usage time for each day of the week with respect to the second content, and calculate a variance for the usage time for each day of the week with respect to the third content. The sum of values obtained by multiplying the respective variances calculated for the first to third contents by a usage ratio of the corresponding contents may be a day pattern index.

To explain one example of a method for calculating a time pattern index, the processor 120 may calculate a variance for the use time for each time of day with respect to each of a plurality of contents on the basis of the history information stored in the memory 110, and calculate a time pattern index on the basis of the calculated variance. For example, in a case that entries are stored for first to third contents, the processor 120 may calculate a variance for the usage time for each time of day with respect to the first content, calculate a variance for the usage time for each time of day with respect to the second content, and calculate a variance for the usage time for each time of day with respect to the third content. The sum of values obtained by multiplying the respective variances calculated for the first to third contents by a usage ratio of the corresponding contents may be a time pattern index.

The usage history on the basis of which the content usage pattern index is calculated may be, for example, a usage history for the past several weeks, the past several days, or may be the entire usage history. An entry that includes a viewing time that is shorter than a predetermined time (e.g., ten minutes) may be ignored.

The processor 120 may determine a weight on the basis of a content usage pattern index for a plurality of contents. For example, information about weights that differ for each content usage pattern index may be pre-stored in the memory 110, and the processor 120 may identify a weight to be associated with an entry according to the pre-stored weight information.

The content usage pattern index may be calculated on the basis of the history information and thus, when the history information is updated according to a usage of the electronic apparatus 100, the content usage pattern index may be recalculated on the basis of the updated history information, and a weight may be also updated on the basis of the recalculated content usage pattern index. The update may be performed for every predetermined cycle.

As described above, according to an embodiment, weights are adaptively changed according to a change in viewing history and thus, content recommendations may advantageously be made according to a recent content usage pattern of the user. In addition, there is an advantage that an on-device real-time content recommendation can be performed on the electronic apparatus 100 instead of a server.

According to an embodiment, the content for recommendation may be identified to the user according to stored viewing history information associated with a plurality of users of a plurality of display devices.

According to another embodiment, content usage history of a user of the electronic apparatus 100 may be compared with aggregated content usage history of many users across many electronic apparatuses, and a weight may be determined according to the comparison. To this end, a content usage pattern index calculated in the electronic apparatus 100 as described above and a content usage pattern index calculated in other electronic apparatuses may be clustered, and thereby a clustered weight may be identified. An operation of clustering content usage pattern indexes may be performed in an external server.

Meanwhile, the electronic apparatus 100 and the other electronic apparatuses may transmit a content usage pattern index to a server, and the server may apply an artificial intelligence (AI) technology to the collected data and identify the characteristic of the content usage pattern of users of the respective electronic apparatuses. It is desirable that the other electronic apparatuses are similar to the electronic apparatus to obtain a more meaningful result. Accordingly, according to an embodiment, the other electronic apparatuses may be similar to the electronic apparatus. For example, the electronic apparatus and the other electronic apparatuses may be TVs that are used in homes located in a particular city.

The AI technology includes a machine learning (deep learning) technology using an algorithm that is capable of teaching itself a characteristic of input data, and element technologies that simulate a function such as recognition, determination, etc. of a human brain by using the machine learning algorithm. From among such element technologies, a server may collect a content usage pattern of the respective electronic apparatuses by using a knowledge expression technology processing experience information of a human being as knowledge data. The knowledge expression is a technique of performing automation processing with respect to experience information of a human with knowledge data, which includes knowledge construction (data generation/classification), knowledge management (data usage) and the like.

For example, the server may cluster content usage pattern indexes into N groups according to the standard deviation of the collected content usage pattern indexes.

As described above, according to an embodiment, a model to identify a recommended content on the basis of history information and a weight may be implemented in the electronic apparatus 100, and a parameter for grouping using a large amount of data may be derived in a server and a model of the electronic apparatus 100 may be updated on the basis of this value. Accordingly, it is possible to reflect a continuously-variable content usage pattern with minimal resources and identify recommended content.

In the example embodiment described above, if content usage pattern indexes belong to the same group, the same weight is applied. However, even if they are in the same group, it is possible that different weights are applied on the basis of a relative position in that group.

Meanwhile, some or all of the operations described to be performed in the server may be performed in the electronic apparatus 100 as well. For example, the electronic apparatus 100 may receive information about a content usage pattern index from the other electronic apparatuses and perform clustering as described above, and determine a weight on the basis of weight information corresponding to a group to which the electronic apparatus 100 belongs.

In addition, some of the operations performed in the electronic apparatus 100 may be performed in the server as well. For example, the electronic apparatus 100 may provide history information to the server and the server may then calculate a content usage pattern index, calculate a usage index, and identify recommended content and provide the recommendations to the electronic apparatus 100. That is, it is possible to control main operations in the server and to control the electronic apparatus 100 to handle only an information output function. However, it is desirable that the history information is maintained locally because it is personal information and thus, it may be preferred that the electronic apparatus 100 transmits a content usage pattern index obtained by processing the history information to the server instead of the history information itself.

Meanwhile, a recommended content having a high usability may be provided on the basis of history information of the other electronic apparatuses rather than history information stored in the electronic apparatus 100. For example, the server may receive history information from at least one of the other electronic apparatuses, calculate a content usage pattern index and a content usage index as described above, on the basis of the received history information and identify a recommended content, and provide information about the identified recommended content to the electronic apparatus. Alternatively, even if the server is not used, the electronic apparatus 100 may directly receive the history information from at least one of the other electronic apparatuses, and calculate a content usage pattern index and a content usage index as described above, using the received history information and identify a recommended content. According to various embodiments, a content preferred by a user of another electronic apparatus may be provided by the electronic apparatus 100.

The processor 120 may calculate a usage index of each of a plurality of contents on the basis of the assigned weight and a usage time for each of the plurality of contents, and identify a preferred content from among the plurality of contents on the basis of the calculated usage index. In addition, a reduction value corresponding to the age of the entry may be applied to calculate a usage index of each of the plurality of contents. In addition, the processor 120 may calculate a content usage pattern index on the basis of the history information, and determine the weight which is used to calculate the usage index on the basis of the calculated content usage pattern index.

A recommended content may be identified on the basis of the embodiment described above with reference to FIG. 4B, and a plurality of recommended contents may be identified. The processor 120 may provide at least one preferred content to the user. For example, history information corresponding to at least one of a day of the week and a time of day for each of a plurality of contents provided by the electronic apparatus 100 may be stored. When a predetermined event occurs, a weight is assigned to entries corresponding to at least one of the day and time on which the event occurs, and a preferred content may be identified from among the plurality of contents on the basis of the entries to which the weight is assigned.

FIG. 5 is a diagram illustrating EPG metadata, according to an embodiment.

Referring to FIG. 5, EPG metadata to identify information about a program by dates may be identified. From the EPG metadata, a viewing date 510 and a time 520 may be identified for a program. Here, the A, B, C, D and E may indicate each of programs. The processor 120 may receive the EPG metadata and identify information about a content currently provided, and generate information relating to a viewing history thereof.

The processor 120 may continuously store information about a viewing history of the user on the basis of the information illustrated in FIGS. 4 and 5, and analyze the preferred content.

One or more embodiments are directed to determining when the analyzed preferred content is to be displayed. As described above, an embodiment provides a preferred content when an advertisement is displayed on the electronic apparatus 100. However, the user may dislike when the preferred content is provided while viewing a preferred advertisement. Accordingly, an embodiment may instead provide a preferred content when an advertisement content not preferred by the user is displayed.

The processor 120 may preferentially identify whether a content currently provided by the electronic apparatus 100 is an advertisement or not. In addition, in order to identify whether an advertisement being currently provided is preferred by the user, it is necessary to identify information about the advertisement.

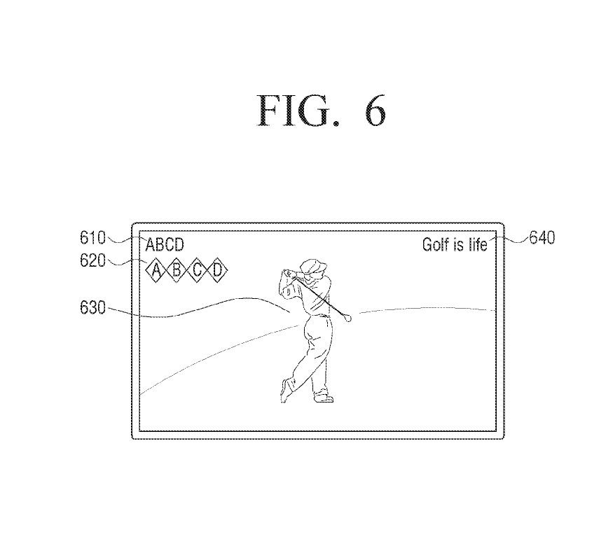

FIG. 6 is a diagram illustrating information about an advertisement content displayed on an electronic apparatus 100.

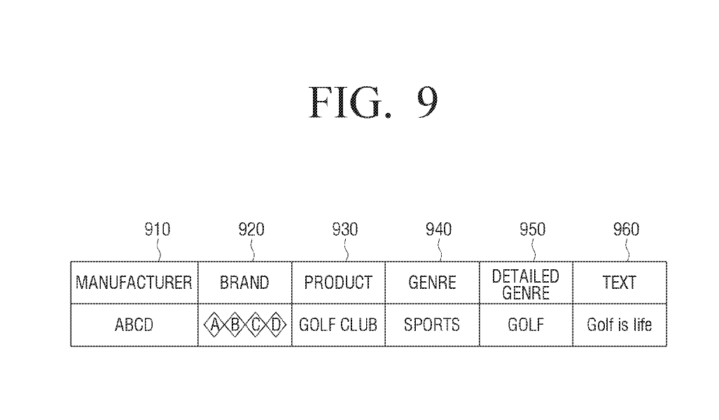

Referring to FIG. 6, a company name 610, a brand name 620, a subject of advertisement 630, an advertisement slogan 640, etc. may be displayed in the advertisement. On the basis of the subject of advertisement 630, various information such as a product of advertisement, a genre, a subgenre and the like may be identified. Here, the information identified through the advertisement may be stored as data, which will be described in detail later with reference to FIG. 9.

If the advertisement identified in FIG. 6 is determined as a low-preferred advertisement content of the user, the processor 120 may display a preferred content.

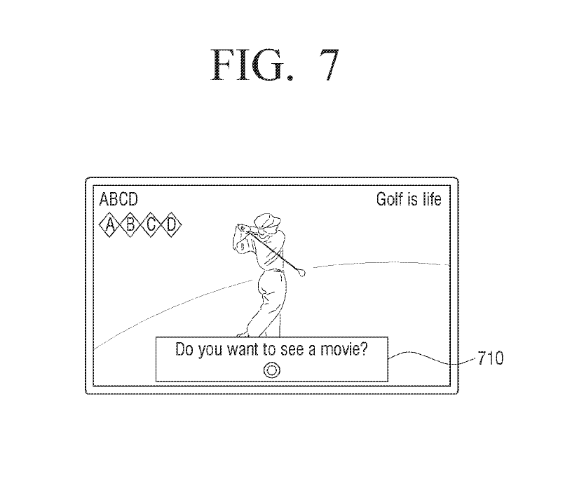

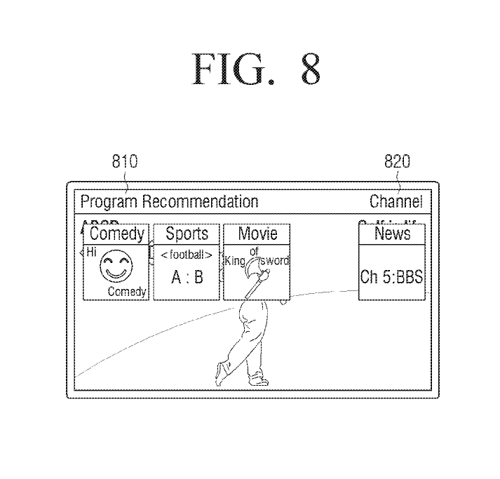

A method for displaying a preferred content will be described with reference to FIGS. 7 and 8.

FIG. 7 is a diagram illustrating an operation of displaying one preferred content.

Referring to FIG. 7, the processor 120 may display a user interface (UI) 710 inquiring whether the user wants to view a new content while a low-preferred advertisement is displayed. In FIG. 7, a UI inquiring whether to see a movie is displayed. However, this is only an example, and the recommended content may be a particular content or an on-air channel.

FIG. 8 is a diagram illustrating an operation of displaying a plurality of preferred contents.

Referring to FIG. 8, the processor 120 may provide a user interface 810 and 820 on which information about a preferred content is displayed, while a low-preferred advertisement is displayed. The UI may recommend a particular program 810, and recommend an on-air channel 820.

Meanwhile, in order to identify whether an advertisement is an advertisement preferred by the user or not, it is necessary to identify accurate information about an advertisement currently provided by the electronic apparatus 100.

In this regard, a format in which the advertisement illustrated in FIG. 6 is stored will be described.

FIG. 9 is a diagram in which the advertisement information displayed in FIG. 6 is displayed.

Referring to FIG. 9, advertisement information displayed on the electronic apparatus 100 may be divided into a company name 910, a brand 920, a product 930, a genre 940, a detailed genre 950 (i.e., subgenre), a text 960, etc. Here, the text may be an advertisement slogan.

In addition, a screen displayed in the advertisement may be analyzed and data including the advertisement information may be generated. If it is determined difficult to accurately identify whether a character or a picture displayed on the displayed screen of the advertisement is a brand or a company name, a plurality of information about the text may be stored.

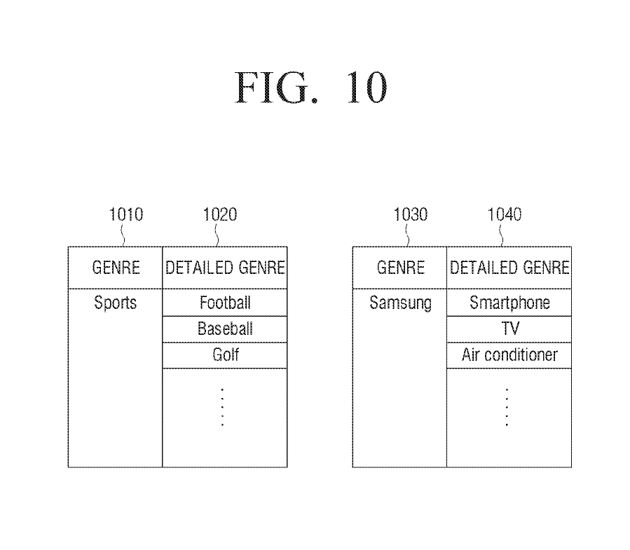

FIG. 10 is a diagram illustrating a genre and a detailed genre included in advertisement information.

Referring to FIG. 10, when the genre 1010 is sports, the detailed genre 1020 may be football, baseball, and golf. In addition, when the genre 1030 is Samsung, the detailed genre 1040 may be smartphone, TV, and an air conditioner. However, the detailed genre is not limited thereto, and various words may be stored as a detailed genre.

The reason why division is made into a genre and a detailed genre is to make comparison of whether the advertisement is an advertisement preferred by the user or not, using a keyword.

FIG. 11 is a diagram illustrating a comparison of keywords, according to an embodiment.

Referring to FIG. 11, a preferred keyword 1110 and an advertisement keyword 1120 may compared with each other.

For example, the preferred keyword 110 may be a favorite search word or a word corresponding to a favorite advertisement of the user. Here, it will be assumed that the user prefers keywords such as football, baseball, and Samsung, upon analysis of information relating to the viewing history.

It may be set to add a preference value of 100 to the keyword and to add a preference value in the range of 10 to 500 to keywords that are similar to the keyword. In addition, a preference value of +30 may be assigned to hypernyms of the similar keywords and a preference value of +10 may be assigned to hyponyms of the similar keywords.

According to the assumption mentioned above, the keyword corresponding to “football” which is a preferred keyword is not present in the advertisement keywords. However, “sports” of the advertisement keyword corresponds to a hypernym of football. In this case, the preference value is +30.

In addition, the keyword corresponding to “baseball” which is a preferred keyword is not present, either, and “sports” which is a hypernym is present. In this case, the preference value is +30.

In addition, it may be determined that the keyword or a similar keyword corresponding to “Samsung” which is a preferred keyword is not present.

To sum up the case described above, “sports” which is a hypernym of football and baseball may be present in the advertisement keywords and may have a preference value of a total of +60. The processor 120 may therefore determine a preference value as 60 for a golf advertisement of the ABCD company.

If it is set such that an advertisement is determined as a preferred advertisement only when a preference value of the user is greater than or equal to 100, the golf advertisement of the ABCD company may be determined as a low-preferred advertisement because its preference value is 60.

However, this method is only an example, and other methods for assigning a preference value and other mathematical process may be used.

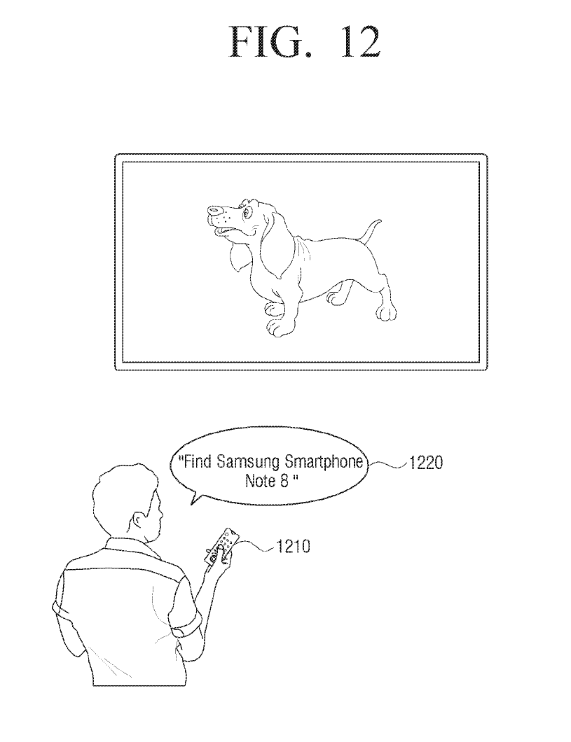

FIG. 12 is a diagram illustrating a voice recognition function, according to another embodiment.

Referring to FIG. 12, the user may search for particular information using a voice recognition function by means of a microphone included in the remote control apparatus 1210. For example, the user may have the remote control apparatus 1210 recognize the phrase “Find Samsung smartphone Note 8” and search for information about Note 8 which is a Samsung smartphone.

Here, the processor 120 may store information found by the user in response to the voice command as a preferred keyword and subsequently determine whether an advertisement is a preferred advertisement or not according to the stored information. The information found by the user is not necessarily used as a keyword, but may be used in various ways in the process of determining whether an advertisement is preferred or not.

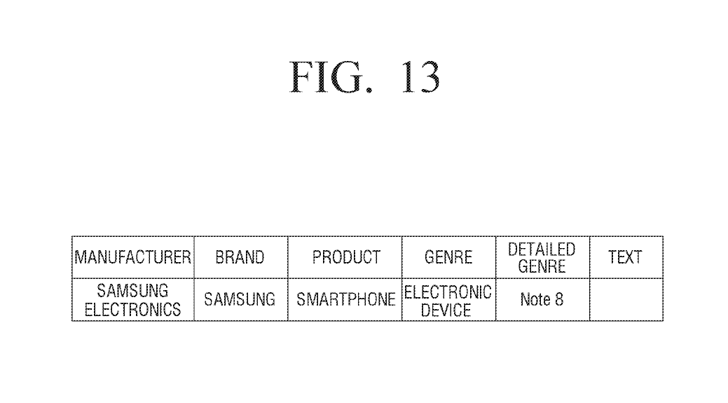

FIG. 13 is a diagram illustrating an operation of storing information received through the voice recognition function according to FIG. 12.

Referring to FIG. 13, the processor 120 may store a phrase 1220 uttered by the user to the remote control apparatus 1210 as data. For example, information about a company name, a brand, a genre, a detailed genre, and a text may be included in the memory 110. The user does not utter a particular phrase in the example described above, and thus text information that is not input may not be stored separately.

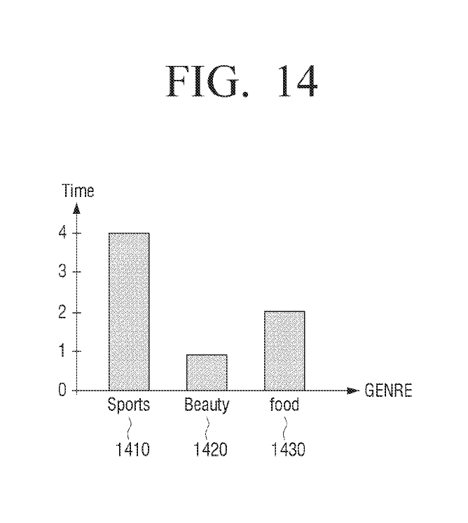

Meanwhile, determination as to whether an advertisement is preferred or not may be made on the basis of a genre of the advertisement. This will be described with reference to FIG. 14.

FIG. 14 is a graph showing a viewing time for each genre with respect to contents viewed by a user.

Referring to FIG. 14, a genre may be divided into three types: sports 1410, beauty 1420, and food 1430. For example, the viewing time by genre may be calculated on the basis of a content viewing history of the user. As described above, a content may correspond to an image data provided to the user by the electronic apparatus 100, such as a program, channel, advertisement and the like. The processor 120 may store a viewing history of a content viewed by the user through the electronic apparatus 100 in the memory 110, and store the viewing time by genre.

For example, it will be assumed that the user purchases the electronic apparatus 100 on Monday and views basketball on the same day for two hours, views a beauty channel on Tuesday for an hour, views a food documentary on Wednesday for two hours, and views a football game on Saturday for two hours. In this case, a cumulative viewing time may be summed up by genre. In this case, the sports 1410 is viewed for four hours, the beauty 1420 viewed for an hour, and the food 1430 is viewed for two hours. The processor 120 may store the information in the memory 110. However, this is only an example, and other items may be added and the number of genres is not limited thereto.

In the example described above, if a cumulative time for which a particular genre is viewed is relatively greater than or equal to a predetermined ratio with respect to total viewing time, the processor 120 may set the particular genre as a preferred advertisement. Here, the cumulative time is a total viewing time of normal content that is not an advertisement. For example, the user frequently viewing sports channels may be determined to prefer sports advertisements.

Referring to FIG. 14, in this case, a genre ratio of sports 1410 is determined as 4/(4+1+2)=0.57. In addition, a ratio of beauty 1420 is 1/(4+1+2)=0.14, and a ratio of food 1430 is 2/(4+1+2)=0.28. The sum of ratios of the genres may not exceed 1, and the number of genres having a ratio of at least 0.5 may not be greater than or equal to 2. The user may set a value as a preferred genre ratio. For example, when the user stores 0.25 as a preferred genre ratio, the sports 1410 and the food 1330 may correspond to preferred genres and the beauty 1420 may correspond to a low-preferred genre. The processor 120 may determine an advertisement regarding beauty as a low-preferred advertisement. This method is only an example, and various mathematical processes may be applied.

Meanwhile, analysis of whether the same advertisement is previously viewed may be used to determine whether an advertisement is a preferred advertisement.

FIG. 15 is a diagram illustrating a beta distribution regarding whether the same advertisement is previously viewed or not.

Referring to FIG. 15, the processor 120 may store data regarding whether the same advertisement is viewed, and use a beta distribution with respect to the stored data. The beta distribution may be a continuous probability distribution which is defined in the interval [0,1] according to two parameters. The PDF refers to a Probability Density Function, and the x axis may be a value between 0 and 1.

Referring to FIG. 15, two parameters may be used as the number of viewing the advertisement and the number of not viewing the advertisement. The number of viewing the advertisement may be a value obtained by counting whether the user has viewed the advertisement. For example, if a total advertisement time is ten seconds, when the user has viewed the corresponding advertisement for nine seconds or more, it may be determined that the user has viewed the advertisement. This threshold may differ depending on the setting of the user. In addition, the number of not viewing may be a value obtained by counting a history of moving to another content when the corresponding advertisement is displayed before the threshold is reached, or opening a menu for content search before the threshold is reached. In this case, various behaviors from which it may be determined that the user has not viewed the corresponding advertisement may be reflected, and are not limited to the above-mentioned examples.

Referring to FIG. 15, a beta distribution for beta (the number of viewing the advertisement and the number of not viewing the advertisement) may be identified. The processor 120 may analyze the beta distribution, and determine whether the advertisement is an advertisement preferred by the user. For example, the Beta(2,8) may be a beta distribution for an advertisement of which the number of views is two and the number of not viewing is eight, the Beta(5,5) may be a beta distribution for an advertisement of which the number of views is five and the number of not viewing is five, and the Beta(8,2) may be a beta distribution of which the number of views is eight and the number of not viewing is two.

FIG. 16 is a graph showing an operation of determining a preferred content on the basis of whether the same advertisement is viewed or not.

Referring to FIG. 16, a beta distribution for beta of which the number of views is eight and the number of not viewing is two may be identified. The processor 120 may identify a maximum of the PDF in the beta distribution, and calculate the x-axis value of a point of which the y-axis value has the highest value. In FIG. 16, the x-axis value may be 0.9. The processor 120 may determine a value obtained using the method described above, as a value for whether the same advertisement is viewed, and if the determined value is greater than or equal to a predetermined value, determine that the advertisement is a preferred advertisement.

For example, it will be assumed that the processor 120 determines the advertisement is a preferred advertisement only when the value for whether the same advertisement is viewed is greater than or equal to 0.6. The processor 120 may determine a value for whether the same advertisement is viewed for an advertisement corresponding to the Beta(8,2) as 0.9, and therefore determine that an advertisement corresponding to the Beta(8,2) is preferred by the user.

Meanwhile, Thomson sampling may be used regarding using the Beta distribution.

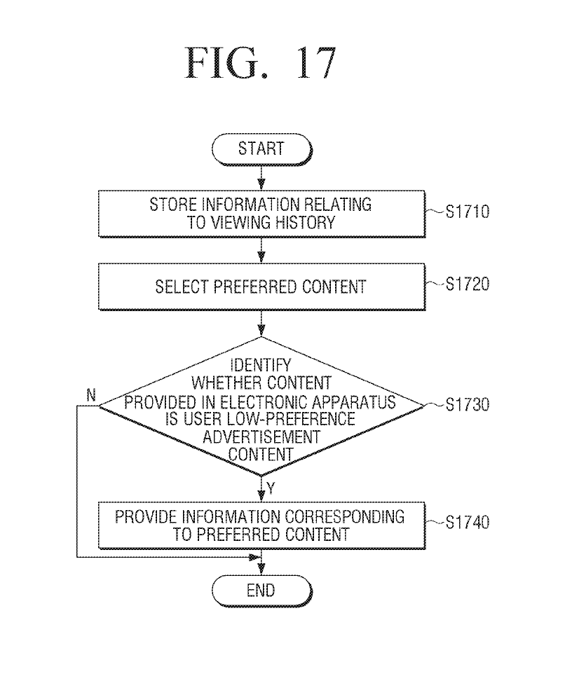

FIG. 17 is a flowchart of a controlling method of an electronic apparatus, according to an example embodiment.

Referring to FIG. 17, a controlling method of an electronic apparatus may include storing information relating to a user viewing history, at operation S1710.

Here, the controlling method of the electronic apparatus may include identifying a user-preferred content on the basis of the stored viewing history information, at operation S1720.

In addition, the controlling method of the electronic apparatus may include identifying whether a content provided by the electronic apparatus is an advertisement content that is not preferred by the user, at operation S1730.

Here, the identifying whether the content is the advertisement content not preferred by the user may include receiving, from a server, advertisement information related to a content provided by the electronic apparatus, and comparing the received advertisement information with the stored viewing history information and identifying whether the advertisement is an advertisement content that is not preferred by the user.

The identifying whether the content is the advertisement content not preferred by the user may include calculating a preference value of the identified advertisement content, and identifying whether the content is a user low-preferred advertisement content on the basis of the calculated preference value.

In addition, the identifying whether the content is the advertisement content not preferred by the user may include identifying a genre of an advertisement content provided by the electronic apparatus, and identifying whether the advertisement content is a user low-preferred advertisement content on the basis of whether the identified genre is preferred by the user or not.

The identifying whether the content is the advertisement content not preferred by the user may include analyzing an image on which the content is displayed and acquiring text included in the image, and identifying whether the image is an advertisement content on the basis of the obtained text.

Here, the identifying whether the advertisement content is a user low-preferred advertisement content may include comparing the acquired text with the stored viewing history information, and identifying whether the content is a user low-preferred advertising content according to a result of the comparison.

In addition, in a case that the content provided by the electronic apparatus is a user low-preferred advertisement content, information corresponding to a preferred content may be provided, at operation S1740. Information corresponding to a preferred content is not provided if the content is preferred by the user.

The identifying operation S1730 may further include identifying whether the content provided by the electronic apparatus is broadcasting content, identifying whether the identified broadcasting content is a user low-preference advertisement content on the basis of the stored viewing history information, and if the identified broadcasting content is a user low-preference advertisement content, providing information corresponding to the identified user-preferred content at operation S1740.

The advertisement information may include at least one of manufacturer information associated with the advertisement content, brand information, product information, content genre information, and text information included in the advertisement content.

In addition, the providing may include repeatedly providing information to the user corresponding to the identified user-preferred content during consecutive units of advertisement content provided in the electronic apparatus.

As described above, the electronic apparatus 100 according to an embodiment may acquire information about an advertisement currently provided in the electronic apparatus 100 and identify whether the advertisement corresponds to a preferred content. Thereby, it is possible to provide the user with information about a preferred content when an advertisement content not preferred by the user is displayed.

In addition, the controlling method of the electronic apparatus 100 according to another embodiment may include receiving the advertisement metadata from an external source, and identifying whether the advertisement content currently provided by the electronic apparatus 100 is an advertisement content not preferred by the user. The advertisement metadata received from an external source may include detailed information and thus, it is possible to accurately analyze whether the content is a content not preferred by the user.

The controlling method of the electronic apparatus 100 according to an embodiment may include, if a low-preferred advertisement is provided, providing information about a preferred content and thus, it is possible to reduce the user's inconvenience and to increase user satisfaction for the processor 120.

In FIG. 17, the processor 120 provides content information for an operation of providing a preferred content. However, in an implementation, display of a preferred content instead of the low-preferred advertisement currently being provided may be performed immediately or after a predetermined time elapses.

The controlling method of the electronic apparatus 100 according to an example embodiment may include performing, by the processor 120, an operation such as immediately displaying a content under a particular condition, etc., and thus the user can readily access a desired content without accessing an additional menu, thereby enhancing the user convenience. In addition, the controlling method of the electronic apparatus 100 as illustrated in FIG. 17 may be performed in, for example, an electronic apparatus having the configuration of FIG. 1 or FIG. 2, and may also be performed in an electronic apparatus having other configurations.

The above-described method of controlling the electronic apparatus 100 according to embodiments described above may be implemented in a program and provided to the electronic apparatus 100. In particular, the program including the controlling method of the electronic apparatus 100 according to embodiments may be stored in a non-transitory computer readable medium and provided therein.

Various embodiments described above may be embodied in a recording medium that may be read by a computer or a similar apparatus to the computer by using software, hardware, or a combination thereof. According to the hardware embodiment, embodiments that are described in the present disclosure may be embodied by using at least one identified from Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electrical units for performing other functions. In some cases, embodiments described herein may be implemented by processor 120 itself. According to a software implementation, embodiments such as the procedures and functions described herein may be implemented with separate software modules. Each of the software modules may perform one or more of the functions and operations described herein.

Meanwhile, the computer instructions for carrying out a processing operation in the electronic apparatus 100 according to various embodiments of the present disclosure described above may be stored in a non-transitory computer-readable medium. Computer instructions stored on such non-transitory computer-readable medium may cause a particular device to perform processing operations in the electronic apparatus 100 according to various embodiments described above when executed by a processor of the particular device.

A computer-readable recording medium including a program for executing a controlling method of the electronic apparatus 100 is provided. The controlling method may include identifying a user-preferred content on the basis of pre-stored viewing history information, and providing information corresponding to the identified user-preferred content. The providing may include, when the content provided by the electronic apparatus is a user low-preferred advertisement content, providing information corresponding to the identified user-preferred content.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

The foregoing embodiments and advantages are merely exemplary and are not to be construed as limiting the present disclosure. The present teaching may be readily applied to other types of devices. Also, the description of the embodiments of the present disclosure is intended to be illustrative, and not to limit the scope of the claims, and many alternatives, modifications, and variations will be apparent to those skilled in the art.

What is claimed is:

1. An electronic apparatus, comprising:
a memory in which viewing history information of a user is stored; and
a processor configured to:
provide content to the user;
identify a user-preferred content based on the stored viewing history information; and
based on the content being provided to the user including an advertisement that is not preferred by the user, provide information to the user corresponding to the identified user-preferred content.

2. The electronic apparatus as claimed in claim 1, wherein the processor is configured to:
identify whether the content being provided to the user is an advertisement; and
identify whether the identified advertisement is the advertisement that is not preferred by the user based on the stored viewing history information.

3. The electronic apparatus as claimed in claim 2, further comprising:
a communication interface configured to receive, from an external server, advertisement information regarding the advertisement provided to the user,
wherein the processor is configured to compare the received advertisement information with the stored viewing history information and identify whether the advertisement provided to the user is preferred or not preferred by the user based on a result of the comparison.

4. The electronic apparatus as claimed in claim 3, wherein the advertisement information includes at least one from among company information, brand information, product information, genre information regarding the advertisement, and information about text included in the advertisement.

5. The electronic apparatus as claimed in claim 2, wherein the processor is configured to:
determine a preference value of the advertisement; and
identify whether the advertisement is preferred or not preferred by the user based on the determined preference value.

6. The electronic apparatus as claimed in claim 2, wherein the processor is configured to:
identify a genre of the advertisement provided to the user; and
identify whether the advertisement is preferred or not preferred by the user based on a user preference for the identified genre included in the stored viewing history information.

7. The electronic apparatus as claimed in claim 2, wherein the processor is configured to:
acquire displayed text included in the content provided to the user; and
identify whether the content being provided to the user includes an advertisement based on the displayed text.

8. The electronic apparatus as claimed in claim 7, wherein the processor is configured to compare the displayed text with the stored viewing history information and, based on a result of the comparison, identify whether the advertisement provided to the user is preferred or not preferred by the user.

9. The electronic apparatus as claimed in claim 1, wherein the processor is configured to repeatedly provide the information to the user corresponding to the identified user-preferred content during consecutive units of advertisement content provided to the user.

10. The electronic apparatus as claimed in claim 1, wherein the processor is configured to, based on the content being provided to the user being the advertisement that is not preferred by the user, provide the identified user-preferred content together with the advertisement that is not preferred by the user.

11. A controlling method of an electronic apparatus, the controlling method comprising:
storing viewing history information of a user;
providing content to the user;
identifying a user-preferred content based on the stored viewing history information; and
based on the content being provided to the user including an advertisement that is not preferred by the user, providing information to the user corresponding to the identified user-preferred content.

12. The controlling method as claimed in claim 11, wherein the providing comprises:
identifying whether the content being provided to the user is an advertisement; and
identifying whether the identified advertisement is the advertisement that is not preferred by the user based on the stored viewing history information.

13. The controlling method as claimed in claim 12, further comprising:
receiving, from an external server, advertisement information regarding the advertisement provided to the user; and
comparing the received advertisement information with the stored viewing history information and identifying whether the advertisement provided to the user is preferred or not preferred by the user based on a result of the comparison.

14. The controlling method as claimed in claim 13, wherein the advertisement information includes at least one from among company information, brand information, product information, genre information regarding the advertisement, and information about text included in the advertisement.

15. The controlling method as claimed in claim 12, wherein the identifying whether the advertisement provided to the user is preferred or not preferred by the user comprises:
determining a preference value of the advertisement; and
identifying whether the advertisement is preferred or not preferred by the user based on the preference value.

16. The controlling method as claimed in claim 12, wherein the identifying whether the advertisement provided to the user is preferred or not preferred by the user comprises:
identifying a genre of the advertisement provided to the user; and
identifying whether the advertisement is preferred or not preferred by the user based on a user preference for the identified genre included in the stored viewing history information.

17. The controlling method as claimed in claim 12, further comprising:
acquiring displayed text included in the content being provided to the user; and
identifying whether the content is an advertisement based on the displayed text.

18. The controlling method as claimed in claim 17, wherein the identifying whether the advertisement provided to the user is preferred or not preferred by the user comprises:
comparing the displayed text with the stored viewing history information and, based on a result of the comparison, identifying whether the advertisement provided to the user is preferred or not preferred by the user.

19. The controlling method as claimed in claim 11, wherein the providing the information corresponding to the identified user-preferred content comprises:
repeatedly providing the information to the user corresponding to the identified user-preferred content during consecutive units of advertisement content provided to the user.

20. A display device comprising:
a display configured to display content to a user;
a memory configured to store viewing history information of the user;
and a processor configured to:
determine whether the displayed content is preferred or not preferred by the user by comparing the displayed content to the stored viewing history information;
based on a determination that the displayed content is not preferred by the user, identify content for recommendation to the user according to the stored viewing history information and output the content for recommendation together with the displayed content.
